(19) United States
(12) Patent Application Publication
(10) Pub. No.: US 2015/0064607 A1
(43) Pub. Date: Mar. 5, 2015

(54) CATALYST FOR HYDROCARBON-FUELED SOLID OXIDE FUEL CELL AND PRODUCTION METHOD THEREOF

(71) Applicant: KOREA INSTITUTE OF SCIENCE AND TECHNOLOGY, Seoul (KR)

(72) Inventors: Kiyong AHN, Seoul (KR); Young-Hoon KIM, Seoul (KR); Soo-young CHO, Seoul (KR); Kyung Joong YOON, Seoul (KR); Byung Kook KIM, Seoul (KR); Hae-Weon LEE, Seoul (KR); Jong Ho LEE, Seoul (KR); Hyoungchul KIM, Seoul (KR)

(73) Assignee: KOREA INSTITUTE OF SCIENCE AND TECHNOLOGY, Seoul (KR)

(21) Appl. No.: 14/105,511

(22) Filed: Dec. 13, 2013

(30) Foreign Application Priority Data
Aug. 30, 2013 (KR) 10-2013-0104019

(51) Int. Cl. H01M 4/90; H01M 4/88

(52) U.S. Cl. CPC H01M 4/9058; H01M 4/885
USPC 429/527; 502/101

(57) ABSTRACT

Disclosed is an electrode catalyst for a hydrocarbon-fueled solid oxide fuel cell. The electrode catalyst includes ceria supports and iridium-nickel alloy nanoparticles dispersed on the surfaces of the ceria supports. The electrode catalyst can be inhibited from carbon deposition, a general phenomenon in conventional hydrocarbon-fueled solid oxide fuel cells. Therefore, the catalytic activity of the electrode catalyst can be maintained even at high temperature for a long period of time. In addition, the electrode catalyst contains a minimum amount of a platinum group metal for inhibiting the occurrence of carbon deposition and has a maximized surface area. Therefore, the electrode catalyst exhibits improved catalytic activity and can be produced at greatly reduced cost while suppressing the occurrence of carbon deposition.

### CROSS-REFERENCE TO RELATED APPLICATIONS

This application claims priority under 35 U.S.C. §119 to Korean Patent Application No. 10-2013-0104019 filed on Aug. 30, 2013 in the Korean Intellectual Property Office, the disclosure of which is incorporated herein by reference in its entirety.

### BACKGROUND OF THE INVENTION

1. Field of the Invention

The present invention relates to an electrode catalyst for a solid oxide fuel cell using a hydrocarbon fuel, and more specifically to an electrode catalyst for a hydrocarbon-fueled solid oxide fuel cell which includes ceria supports and iridium-nickel composite nanoparticles attached to the ceria supports, and a method for producing the electrode catalyst.

2. Description of the Related Art

Solid oxide fuel cells are fuel cells that use solid oxides as electrolytes and operate at high temperatures of 800 to 1000 ° C. For these reason, solid oxide fuel cells are fuel cells have the highest energy conversion efficiency and can use various types of fuels. In addition, solid oxide fuel cells can be easily constructed into systems of various capacities adapted to demands for power due to their high degree of freedom in terms of size, shape, and capacity. Due to these advantages, solid oxide fuel cells can be utilized in various applications and are particularly suitable as power sources for small electronic devices.

With increasing consumers' willingness to buy microelectronic products, electronics companies have made a great investment in the microminiaturization of electronic devices. For this purpose. the miniaturization of power supplies is considered an essential factor. Under these circumstances, attempts have been made in recent years to directly supply hydrocarbon fuels such as methane (CH₄) to stacks without fuel processors. The direct use of hydrocarbon fuels leads to carbon deposition that causes failure of anodes, making long-term use of fuel cells impossible.

At present, Ni—YSZ cermets are most generally used as anodes of solid oxide fuel cells. Ni—YSZ cermets are inexpensive, are stable in a reducing atmosphere at high temperature, and have sufficient electronic conductivity and catalytic activity for the reaction of hydrogen at general operating temperatures of solid oxide fuel cells. Nickel is a superior catalyst for the electrochemical reaction of hydrogen but causes carbon deposition when natural gas or methane is used as a direct fuel, bringing about a significant increase in activation polarization. The increased activation polarization greatly deteriorates the performance of cells, making it impossible to operate the cells any longer.

As a solution to such problems, Korean Patent Publication No. 10-2004-0111478 proposes an electrode for a solid oxide fuel cell. This patent publication features that the electrode is produced by molding granules consisting of starch particles and fine nickel oxide and zirconia particles surrounding the starch particles. The granules are strong enough not to be destroyed during high-temperature molding and sintering. The granules are highly gas permeable due to their high porosity. However, when hydrocarbon fuels are directly used, the electrode has the problems of poor resistance to carbon deposition and low catalytic activity.

Professor Linic's group at the University of Michigan in USA developed tin-doped nickel catalysts (Journal of Catalysis, 250 (2007) 85-93). Despite further improved stability of the catalysts, low reactivity of the doped tin greatly deteriorates the catalytic activity of the catalysts. Furthermore, an additional supply of water vapor is required for the reforming reactions of hydrocarbons.

### SUMMARY OF THE INVENTION

It is an object of the present invention to provide an electrode catalyst for a hydrocarbon-fueled solid oxide fuel cell that contains a minimum amount of iridium and is effectively inhibited from deterioration of catalytic activity resulting from carbon deposition so that its catalytic activity is maintained for a long period of time, and a method for producing the electrode catalyst.

One aspect of the present invention provides an electrode catalyst for a hydrocarbon-fueled solid oxide fuel cell which includes ceria supports and iridium-nickel composite nanoparticles dispersed on the surfaces of the ceria supports.

According to one embodiment of the present invention, the ceria supports may have an average particle diameter of 25 to 150 nm and the composite nanoparticles may have an average particle diameter of 5 to 20 nm.

The weight ratio of nickel metal particles to iridium metal particles in the composite nanoparticles may be from 50:1 to 5:1.

The iridium metal particles may be present in an amount of 0.06 to 0.3 moles per mole of the composite nanoparticles.

The composite nanoparticles supported on the ceria supports in the electrode catalyst of the present invention may be crystalline alloy nanoparticles consisting of a plurality of nickel metal particles and a plurality of iridium metal particles, and at least one of the iridium metal particles may be present in the surface layer of each crystalline alloy nanoparticle.

Each of the composite nanoparticles may be a core-shell structured composite consisting of a core layer composed of a plurality of nickel metal particles and a shell layer composed of at least one iridium metal particle and a plurality of nickel metal particles.

Another aspect of the present invention provides a method for producing an electrode catalyst for a hydrocarbon-fueled solid oxide fuel cell, the method including (a) dissolving a nickel precursor and an iridium precursor in a mixed solvent of water and an alcohol to prepare a mixed precursor solution, (b) mixing the mixed precursor solution with an aqueous slurry of ceria and heating the mixture to remove the solvents by evaporation, (c) drying the resulting mixture and calcining the dried mixture to remove impurities, and (d) reducing the calcined mixture.

The electrode catalyst of the present invention can be inhibited from carbon deposition, a general phenomenon in conventional hydrocarbon-fueled solid oxide fuel cells. Therefore, the catalytic activity of the electrode catalyst according to the present invention can be maintained even at high temperature for a long period of time. In addition, the electrode catalyst of the present invention contains a minimum amount of a platinum group metal for inhibiting the occurrence of carbon deposition and has a maximized surface area. Therefore, the electrode catalyst of the present invention exhibits improved catalytic activity and can be produced at greatly reduced cost while suppressing the occurrence of carbon deposition.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a transmission electron microscopy (TEM) image showing a state in which carbon was deposited on the surface of a nickel catalyst after the use of methane (CH₄) as a fuel;

FIG. 2 is a schematic diagram illustrating the structure of an electrode catalyst for a hydrocarbon-fueled solid oxide fuel cell according to the present invention;

FIG. 3 is a flowchart illustrating a method for producing an electrode catalyst for a hydrocarbon-fueled solid oxide fuel cell according to the present invention;

FIG. 4 is a graph showing the hydrogen selectivity of catalysts produced in Comparative Examples 1 to 4 after partial oxidation of methane was induced by the respective catalysts to verify the performance of the catalysts;

FIG. 5 shows (a) a transmission electron microscopy (TEM) image measured to confirm the structure of an electrode catalyst for a solid oxide fuel cell produced in Example 1 and shows (b) the results of energy dispersive X-ray spectroscopy (EDX) for the catalyst;

FIG. 6 is a graph showing the segregation energy of iridium depending on the position of iridium in composite nanoparticles included in an electrode catalyst for a solid oxide fuel cell produced in Example 1;

FIG. 7 is a graph showing changes in surface free energy as a function of iridium chemical potential in order to verify how much the content of iridium in the surface layers of composite nanoparticles in an electrode catalyst for a solid oxide fuel cell produced in Example 1 affected the change of surface phase;

FIG. 8 diagrammatically illustrates the deposition of carbon depending on the content of iridium in an electrode catalyst for a solid oxide fuel cell according to the present invention;

FIG. 9 is a graph showing a change in the content of carbon deposited as a function of iridium content after thermal pyrolysis reaction of methane was induced by an electrode catalyst for a solid oxide fuel cell produced in Example 1;

FIG. 10 is a graph showing the weights of electrode catalysts for solid oxide fuel cells produced in Examples 1 to 3 and Comparative Example 1 after thermal pyrolysis reaction of methane;

FIG. 11 is a graph showing changes in the migration energy of carbon adsorbed to the surface of an electrode catalyst for a solid oxide fuel cell produced by a method of the present invention in order to verify the inhibitory effect of iridium contained in the electrode catalyst against carbon deposition; and

FIG. 12 is a simulation diagram illustrating the adsorption of graphene on the surfaces of nickel-iridium composite nanoparticles according to the present invention.

### DETAILED DESCRIPTION OF THE INVENTION

An electrode catalyst for a solid oxide fuel cell according to the present invention will now be described in more detail.

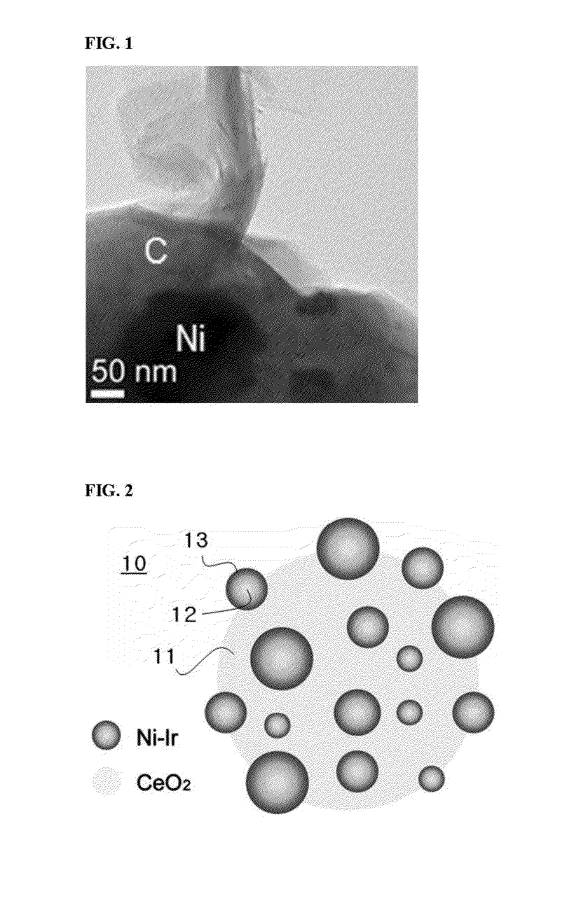

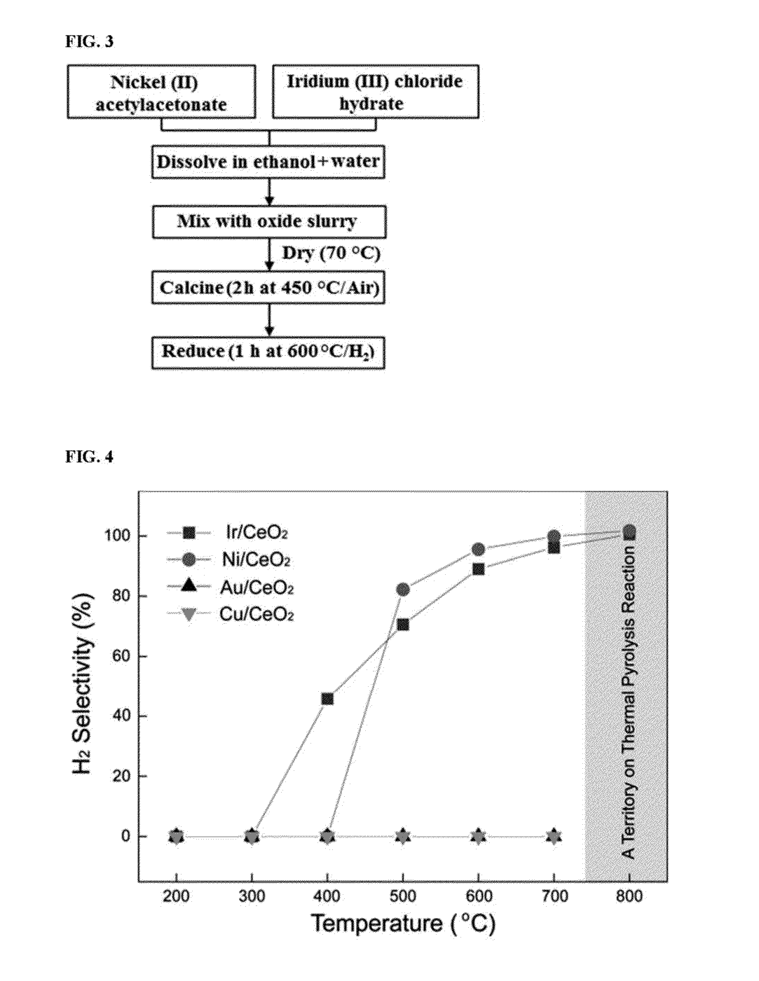

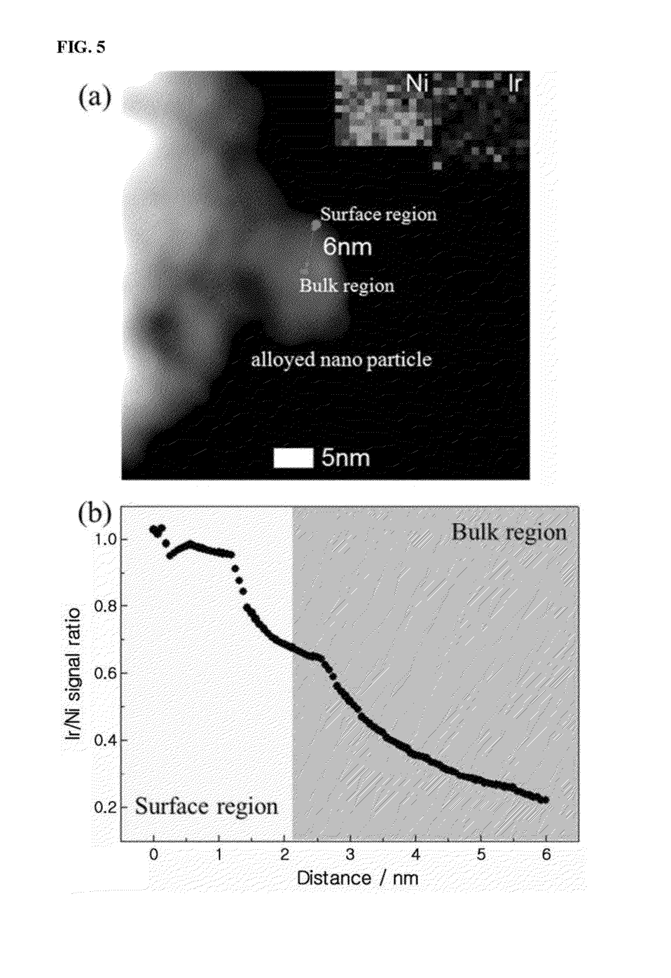

FIG. 1 is a transmission electron microscopy (TEM) image showing a state in which carbon was deposited on the surface of a conventional nickel catalyst after the use of methane (CH₄) as a fuel. Carbon atoms are deposited on the surface of nickel, resulting in a reduction in the substantial reactive surface area of the electrode. In addition, homogeneity of the reaction is deteriorated, causing a partial temperature deviation. As a result, the materials of the solid oxide fuel cell may undergo failure.

Therefore, the present invention has been made in an effort to solve problems associated with the adsorption and deposition of carbon on nickel metal for an anode of a solid oxide fuel cell in an atmosphere using a hydrocarbon fuel, and is intended to provide an electrode catalyst for a solid oxide fuel cell in which highly carbon resistant iridium is mixed with nickel to form an alloy or complex, and the alloy or complex is supported on a metal oxide to achieve further improved catalytic activity.

It is important to optimize the content of iridium in the electrode catalyst in order to minimize the production cost of an electrode catalyst for a solid oxide fuel cell and increase the resistance of the electrode catalyst to carbon deposition. In view of this, the present invention is intended to provide a core-shell structured electrode catalyst for a solid oxide fuel cell in which iridium is present in the surface layers of crystalline composite nanoparticles.

FIG. 2 is a schematic diagram illustrating the structure of an electrode catalyst for a hydrocarbon-fueled solid oxide fuel cell according to the present invention. The electrode catalyst 100 includes ceria supports 11 and iridium-nickel composite nanoparticles 10 dispersed on the surfaces of the ceria supports 11.

Each of the composite nanoparticles consists of a surface layer 13 including at least one iridium atom and an inner layer 12 including nickel. The composite nanoparticles are characterized in that the content of the iridium in the surface layers is in the range of 0.06 to 0.3 moles per mole of the composite nanoparticles. Outside this range, the effect of enhancing the catalytic activity of the catalyst may be deteriorated.

In the electrode catalyst of the present invention, iridium may be arranged in a portion of the core layer or the entire surface of each composite nanoparticle. This arrangement minimizes the reaction area between nickel and a hydrocarbon fuel so that carbon deposition can be inhibited. For practical use of the electrode catalyst, it is preferred to limit the content of expensive iridium in terms of a balance between cost and effect. For the purpose of utilizing iridium as much as possible, iridium is dispersed in the surface layers of the composite nanoparticles to ensure a larger surface area of the iridium.

Iridium is arranged in the surface layers of the composite nanoparticles. With this arrangement, high utilization efficiency of iridium can be achieved and the amount of expensive iridium used can be considerably reduced, enabling a significant cost reduction.

The supports are elements that support the composite nanoparticles thereon. The supports may be composed of a material that are mechanically, thermally or chemically stable and can support the composite nanoparticles. The material for the supports may be a metal oxide, such as Al₂O₃, SiO₂, MgO, MnO, ZnO, TiO₂, ZrO₂ or CeO₂. In a preferred of the present invention, the supports may be composed of ceria (CeO₂).

The weight ratio of nickel to iridium in the electrode catalyst of the present invention is preferably from 50:1 to 5:1. If the nickel content exceeds the upper limit (i.e. 50:1), the effect improving the catalytic activity of the catalyst is relatively low despite the excessive amount of nickel. Meanwhile, if the nickel content is less than the lower limit (i.e. 5:1), a large amount of expensive iridium is used, which is undesirable.

Within this content range, the electrode catalyst including the composite nanoparticles can be used for partial oxidation of methane and reforming reactions such as steam reforming and CO₂ reforming.

The occurrence of carbon deposition in the course of reforming a hydrocarbon fuel may deteriorate the catalytic activity of the nickel included in the core layers of the composite nanoparticles. In the present invention, iridium is arranged in a portion of the surface layer or the entire surface of each composite nanoparticle to suppress the occurrence of carbon deposition.

Iridium (Ir) included in a portion of the surface layer of each composite nanoparticle exhibits superior catalytic activity to other platinum group elements due to its high hydrogen selectivity.

In the electrode catalyst of the present invention, the ceria supports may have an average particle diameter of 25 to 150 nm and the composite nanoparticles may have an average particle diameter of 5 to 20 nm.

In the electrode catalyst of the present invention, the composite nanoparticles may have two forms. Specifically, the composite nanoparticles may be mixed alloys in which the central portions including nickel are alloyed with the surface layers including iridium. Alternatively, the composite nanoparticles may be core-shell structured nanocomposites. The composite nanoparticles may have either or both of the two forms and may be attached to the supports.

That is, the composite nanoparticles supported on the ceria supports in the electrode catalyst of the present invention may be crystalline alloy nanoparticles consisting of a plurality of nickel metal particles and a plurality of iridium metal particles, and at least one of the iridium metal particles may be present in the surface layer of each crystalline alloy nanoparticle.

Each of the composite nanoparticles may be a core-shell structured composite nanopowder consisting of a core layer composed of a plurality of nickel metal particles and a shell layer composed of at least one iridium metal particle and nickel metal particles.

The present invention also provides a method for producing the electrode catalyst for a hydrocarbon-fueled solid oxide fuel cell. Specifically, the present invention includes (a) dissolving a nickel precursor and an iridium precursor in a mixed solvent of water and an alcohol to prepare a mixed precursor solution, (b) mixing the mixed precursor solution with an aqueous slurry of ceria and heating the mixture to remove the solvents by evaporation, (c) drying the resulting mixture and calcining the dried mixture to remove impurities, and (d) reducing the calcined mixture.

In the method of the present invention, the nickel precursor may be nickel (II) acetylaeetonate and the iridium precursor may be iridium (III) chloride hydrate.

First, the nickel precursor and the iridium precursor are dissolved in water, an organic solvent, or a mixed solvent of water and an organic solvent. The mixed solvent may include 30 to 70% by weight of the organic solvent, based on the total weight thereof. Thereafter, the oxide precursor as a support material is dissolved in distilled water to prepare an oxide precursor slurry. Each of the aqueous precursor solution and the oxide precursor slurry may further include at least one additive. The additive is not limited so long as it does not affect the catalytic activity of the electrode catalyst produced by the method of the present invention.

The organic solvent is preferably an alcohol. In a preferred embodiment of the present invention, the organic solvent may be methanol or ethanol.

Next, the mixed precursor solution is mixed with the ceria powder. In this step, the mixture is heated to 70 to 90° C. with stirring to remove the solvents by evaporation. Optionally, the resulting mixture may be dried at 70 to 90° C. depending on the state thereof.

Finally, the dried mixture is calcined at 350 to 550° C. for 0.5 to 4 hours to remove residual impurities and is reduced under a hydrogen atmosphere at 500 to 900° C. to produce the electrode catalyst of the present invention.

The method of the present invention may further include annealing the reduced mixture in a reaction furnace under vacuum, at ambient pressure or under pressure. This annealing may further increase the crystallinity of the electrode catalyst. The reduced mixture may undergo thermal pyrolysis to obtain various phases. The type of the reaction furnace may be varied depending on a desired phase of the electrode catalyst through the thermal pyrolysis. The electrode catalyst thus produced has a structure in which the crystalline alloy or composite nanopowder particles of iridium and nickel are dispersed and supported on the ceria surfaces.

The present invention will be explained in more detail with reference to the following examples. IIowever, these examples serve to provide further appreciation of the invention and it will be obvious to those with ordinary knowledge in the art that they are not intended to limit the scope of the invention.

### EXAMPLES

### Example 1

Nickel (II) acetylacetonate and iridium (III) chloride hydrate as metal precursors were dissolved in an aqueous ethanolic solution (distilled water:ethanol=50:50 (w/w)). The solution was added to and mixed with a solution of ceria (CeO₂) in distilled water. The weight ratio of the nickel to the iridium was adjusted to 50:1. The mixed solution was heated to 80° C. with stirring to remove the solvents by evaporation. Thereafter, the mixture was completely dried in an oven at 80° C., calcined at 450° C. for 2 h to remove impurities, and reduced under a hydrogen atmosphere at 600° C. for 1 h to produce an electrode catalyst for a solid oxide fuel cell.

### Examples 2-3

In Examples 2-3, the procedure of Example 1 was repeated except that the weight ratios of nickel metal to iridium metal were adjusted to 10:1 and 5:1, respectively.

### Comparative Example 1

### Pure Nickel Catalyst Supported on Ceria (Ni—CeO₂)

Nickel (II) acetylacetonate as a metal precursor was dissolved in an aqueous ethanolic solution (distilled water:ethanol=50:50 (w/w)). The solution was added to and mixed with a solution of ceria (CeO₂) in distilled water. The nickel metal was supported in an amount of 5 wt %, based on the ceria weight. The mixed solution was heated to 80° C. with stirring to remove the solvents by evaporation. Thereafter, the mixture was completely dried in an oven at 80° C., calcined at 450° C. for 2 h to remove impurities, and reduced under a hydrogen atmosphere at 600° C. for 1 h to produce a pure nickel catalyst supported on the ceria.

### Comparative Example 2

### Pure Iridium Catalyst Supported on Ceria (Ir—CeO₂)

The procedure of Comparative Example 1 was repeated except that iridium (III) chloride hydrate was used as a metal precursor instead of nickel (II) acetylacetonate.

### Comparative Example 3

### Pure Platinum Catalyst Supported on Ceria (Au—CeO₂)

The procedure of Comparative Example 1 was repeated except that HAuCl₄:3H₂O was used instead of nickel (II) acetylacetonate.

### Comparative Example 4

### Pure Copper Catalyst Supported on Ceria (Cu—CeO₂)

The procedure of Comparative Example 1 was repeated except that CuCl₂.H₂O was used instead of nickel (II) acetylacetonate.

FIG. 4 is a graph showing hydrogen selectivity of the catalysts produced in Comparative Examples 1-4 after partial oxidation of methane was induced by the respective catalysts to verify the performance of the catalysts. The graph confirmed that the catalysts produced in Comparative Examples 1-2 showed the most superior performance.

FIG. 5 shows (a) a transmission electron microscopy (TEM) image measured to confirm the microstructure of the electrode catalyst produced in Example 1 and (b) graphically shows the results of energy dispersive X-ray spectroscopy (EDX) for the catalyst. As can be seen from FIG. 5, the composite nanoparticle of nickel and iridium in the electrode catalyst produced in Example 1 had an average particle diameter of about 10 nm and the iridium metal was present in the surface layer forming the composite nanoparticle.

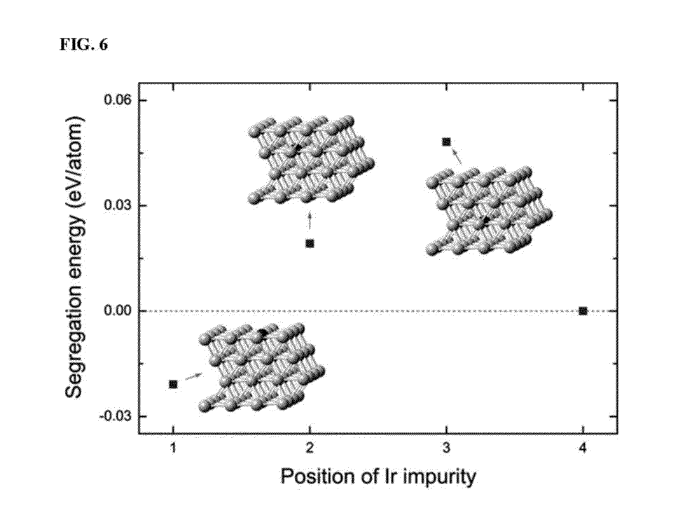

FIG. 6 is a graph showing the segregation energy of iridium depending on the position of iridium in the composite nanoparticles included in the electrode catalyst produced in Example 1. The segregation energy was determined based on the first-principles calculation. From these results, it could be confirmed that iridium dispersed and positioned on the surface layers of the composite nanoparticles of the electrode catalyst was energetically most stable.

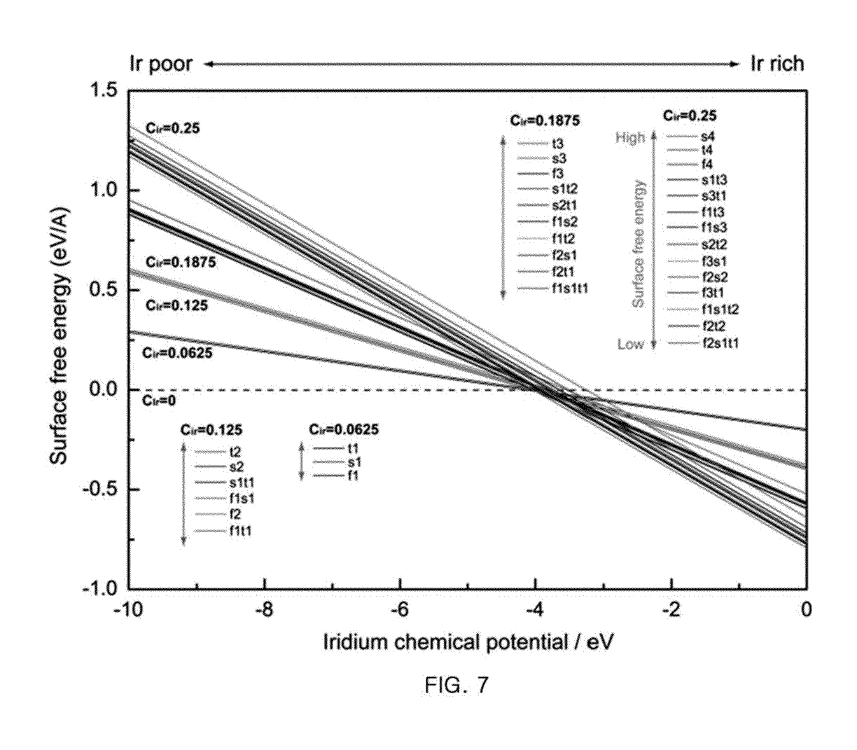

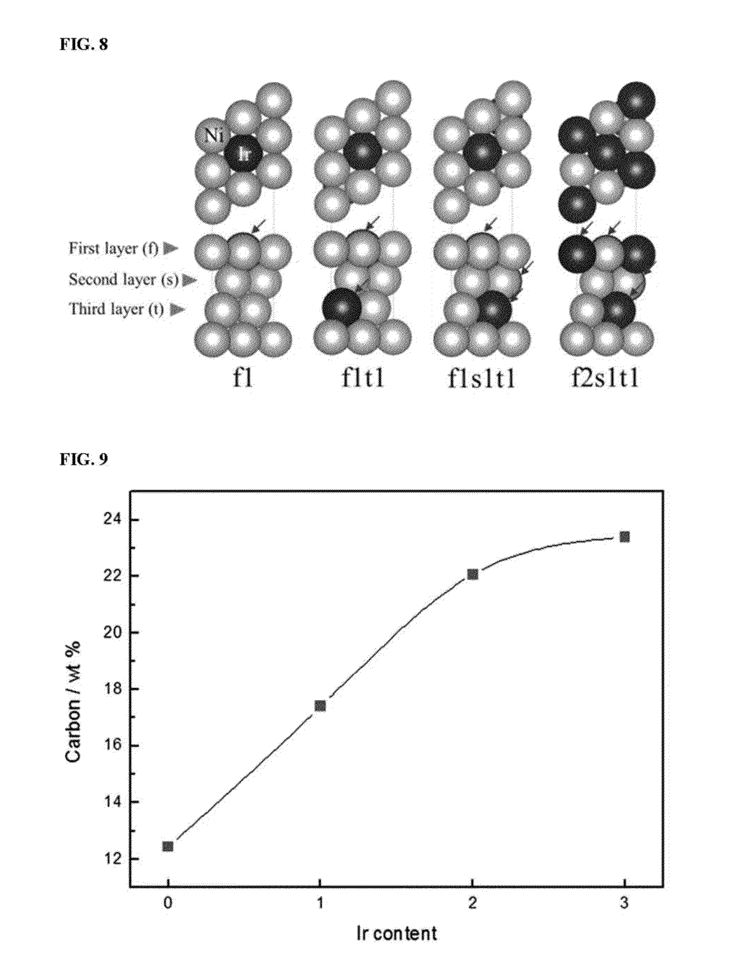

FIG. 7 is a graph showing changes in surface free energy as a function of iridium chemical potential in order to verify how much the content of iridium in the surface layers of the composite nanoparticles in the electrode catalyst produced in Example 1 affected the change of surface phase. The composite nanoparticles were most stable at iridium densities of 0.0625, 0.125, 0.1875, and 0.25. At each density, the crystal structures f1, f1t1, f1s1t1, and f2s1t1 were found to be most stable. Such crystal structures are shown in FIG. 8. Referring to FIGS. 7 and 8, as the density of iridium in the alloy increased, a portion of the iridium was present inside the alloy nanoparticles. However, the alloy nanoparticles were most stable when iridium was present on the nickel surface.

FIG. 9 is a graph showing a change in the content of carbon deposited as a function of iridium content after thermal pyrolysis reaction of methane was induced by the electrode catalyst produced in Example 1. The thermal pyrolysis reaction of methane was carried out at 600° C. for 15 min. These results represent the ability of the electrode catalyst to decompose methane because there was no source (air or oxygen) capable of carbon removal.

As can be seen from FIG. 9, the deposited amount of carbon increased with increasing iridium content. This implies that the catalytic activity of the electrode catalyst for the decomposition of methane increased with increasing iridium content.

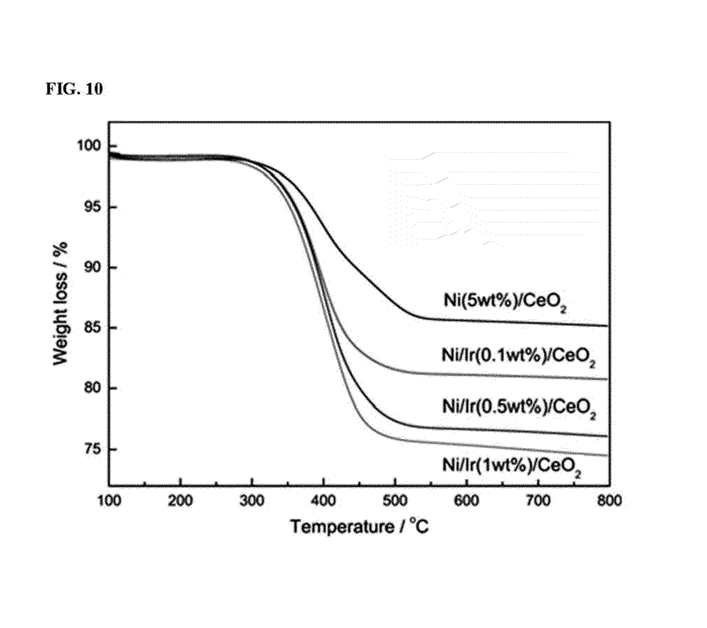

For more detailed results, the weights of the electrode catalysts produced in Examples 1-3 and Comparative Example 1 after thermal pyrolysis reaction of methane were measured using a thermogravimetric analyzer. The results are shown in FIG. 10. Referring to FIG. 10, carbon was effectively removed with less energy as the iridium content increased.

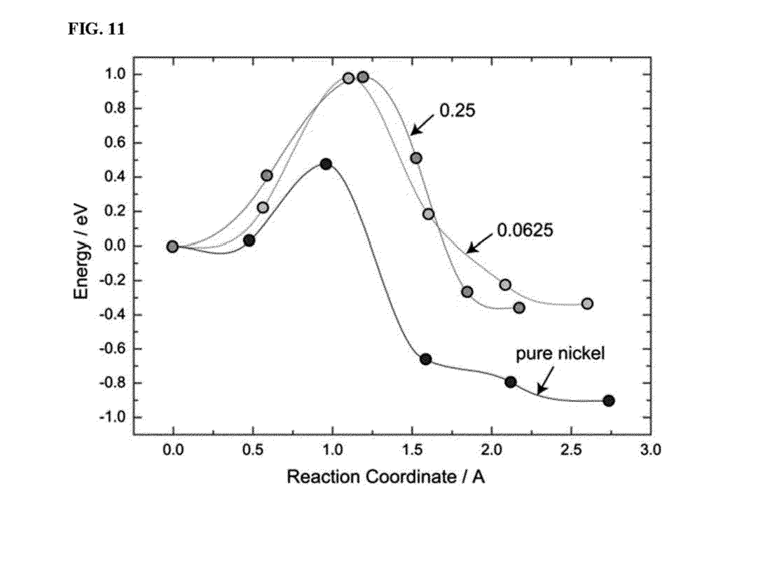

FIG. 11 is a graph showing changes in the migration energy of carbon adsorbed to the surface of the electrode catalyst produced by the method of the present invention in order to verify the inhibitory effect of iridium contained in the electrode catalyst against carbon deposition. The value of energy barrier was increased when iridium was added, but the energy barrier was not changed (increased or decreased) any more when the iridium content exceeded 0.25 moles. The largest energy barrier was observed when the content of iridium in the outermost layers of the alloy nanoparticles was 0.0625 moles.

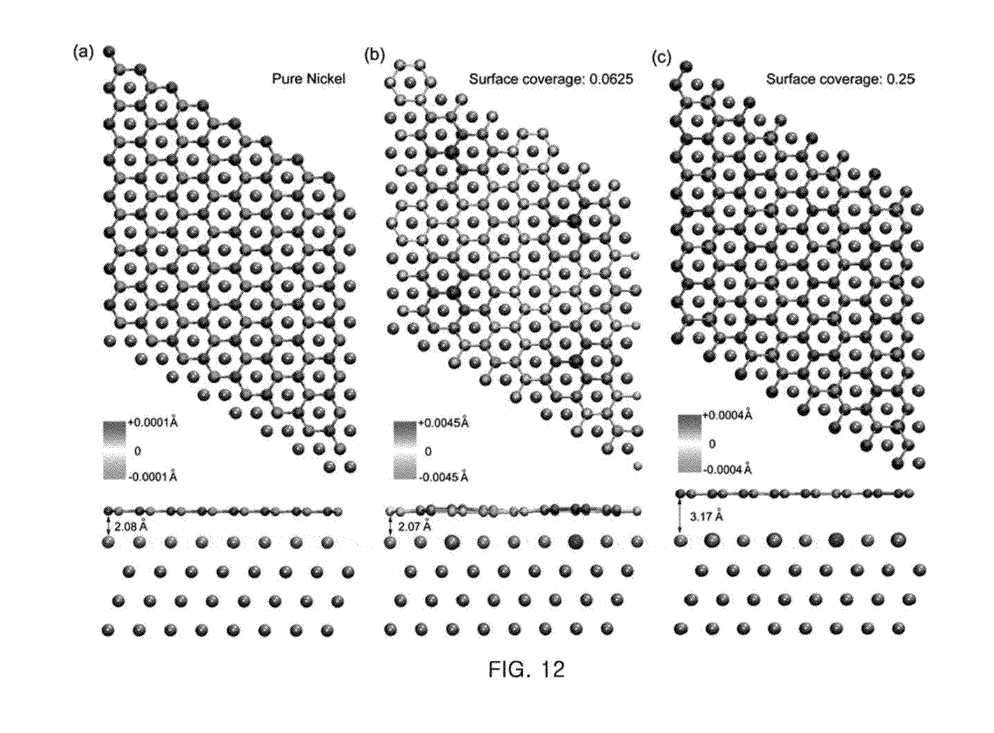

FIG. 12 is a simulation diagram illustrating the adsorption of graphene on the surfaces of the nickel-iridium alloy nanoparticles according to the present invention. When the iridium content was low, carbon atoms located close to iridium had weak bonding strength, and as a result, the graphene was severely wrinkled. When the iridium content increased, the number of wrinkles in the graphene was decreased but the bonding length between the catalyst and the carbon was increased, resulting in weak bonding strength. From these results, it can be seen that energy barrier required for carbon clustering was increased and the occurrence of wrinkles was induced after carbon clustering, leading to resistance to carbon deposition. In addition, an increased content of iridium in the outermost layers of the nickel-iridium alloy nanoparticles greatly lowered the bonding strength with carbon and led to effective removal of carbon.

What is claimed is:

1. An electrode catalyst for a hydrocarbon-fueled solid oxide fuel cell comprising ceria supports and iridium-nickel composite nanoparticles dispersed on the surfaces of the ceria supports.

2. The electrode catalyst according to claim 1, wherein the ceria supports have an average particle diameter of 25 to 150 nm and the composite nanoparticles have an average particle diameter of 5 to 20 nm.

3. The electrode catalyst according to claim 1, wherein the weight ratio of nickel metal particles to iridium metal particles in the composite nanoparticles is from 50:1 to 5:1.

4. The electrode catalyst according to claim 1, wherein the composite nanoparticles are crystalline alloy nanoparticles consisting of a plurality of nickel metal particles and a plurality of iridium metal particles, and the iridium metal particles are present in the surface layer of each crystalline alloy nanoparticle.

5. The electrode catalyst according to claim 1, wherein each of the composite nanoparticles is a core-shell structure consisting of a core layer composed of a plurality of nickel metal particles and a shell layer composed of at least one iridium metal particle and a plurality of nickel metal particles.

6. The electrode catalyst according to claim 4, wherein the iridium metal particles are present in an amount of 0.06 to 0.3 moles per mole of the composite nanoparticles.

7. A method for producing an electrode catalyst for a hydrocarbon-fueled solid oxide fuel cell, the method comprising:
(a) dissolving a nickel precursor and an iridium precursor in a mixed solvent of water and an alcohol to prepare a mixed precursor solution;
(b) mixing the mixed precursor solution with an aqueous slurry of ceria and heating the mixture to remove the solvents by evaporation;
(c) drying the resulting mixture and calcining the dried mixture to remove impurities; and
(d) reducing the calcined mixture,
wherein the nickel precursor is nickel (II) acetylacetonate and the iridium precursor may be iridium (III) chloride hydrate, and
the electrode support comprises ceria supports and iridium-nickel composite nanoparticles dispersed on the surfaces of the ceria supports.

8. The method according to claim 7, wherein the heating in step (b) and the drying in step (c) are performed at 70 to 90° C.

9. The method according to claim 7, wherein the calcining in step (d) is performed at 350 to 550° C. for 0.5 to 4 hours.

10. The method according to claim 8, wherein the reduction in step (d) is performed under a hydrogen atmosphere at 500 to 900° C.
